(19) United States
(12) Patent Application Publication
(10) Pub. No.: US 2016/0186808 A1
(43) Pub. Date: Jun. 30, 2016

(54) ROTARY TABLE BEARING DEVICE

(71) Applicant: SCHAEFFLER TECHNOLOGIES AG & CO. KG, Herzogenaurach (DE)

(72) Inventor: Jorg-Oliver Hestermann, Aurachtal (DE)

(73) Assignee: Schaeffler Technologies AG & Co. KG, Herzogenaurach (DE)

(21) Appl. No.: 14/909,603

(22) PCT Filed: Jul. 2, 2014
(86) PCT No.: PCT/DE2014/200294

§ 371 Date: Feb. 2, 2016

(30) Foreign Application Priority Data
Aug. 13, 2013 (DE) 102013215962.5

(51) Int. Cl. F16C 33/36; F16C 33/58; B23Q 1/52; F16C 19/36

(52) U.S. Cl. CPC F16C 33/363; F16C 19/36; F16C 33/585; B23Q 1/52

(57) ABSTRACT

A rotary table bearing device (1) is provided for supporting a rotary table in a rotatable and axially fixed manner with respect to a stationary frame by a roller bearing. In order to develop a rotary table bearing device (1) simply and with a high load rating, the roller bearing is formed by a single planetary roller bearing (2). The single planetary roller bearing (2) has two bearing rings (3, 4), one of which is associated with the frame and the other of which is associated with the rotary table and which have grooved profiles (7, 8), and planetary rolling elements (10), which are arranged in such a way that the planetary rolling elements are distributed over the circumference and have an outer profile (11) that is complementary to the grooved profiles (7, 8).

### FIELD OF THE INVENTION

The invention relates to a rotary table bearing device for supporting a rotary table so that it can rotate and is fixed in the axial direction relative to a stationary frame by a roller bearing.

### BACKGROUND

Rotary tables are used, for example, in cutting and non-cutting processes for the clamping of workpieces in machine tools and in the automation of production sequences. Here, the rotary table rotates in a frame. Due to high load-carrying requirements and accuracy of the rotation of the rotary table relative to the frame, roller bearings usually formed separately are used with an axial bearing part and a radial bearing part. Usually radial-axial cylinder roller bearings, two-row angled-contact roller bearings, two-row axial angled-contact ball bearings, cross roller bearings are used for supporting rotary tables. For example, from DE 100 10 295 A1 and DE 10 2007 023 242 A1, such roller bearings are known. Here, the load carrying capacity is limited to a point contact or line contact between the roller bodies and the raceways of the bearing rings, so that, for a specified load, a corresponding load rating must be provided with relatively large roller body diameters, so that the roller bearing requires a large installation space.

The objective of the invention is the advantageous refinement of rotary table bearing devices, especially in light of a high load with low installation space.

### SUMMARY

The objective is achieved by the subject matter of the invention with advantageous embodiments being described below.

The present rotary table bearing device is provided for supporting a rotary table so that it can rotate and is fixed in the axial direction relative to a stationary frame by a roller bearing. This roller bearing is formed from a single planetary roller bearing with an advantageously one-part bearing ring allocated to the frame and to the rotary table with groove profiles that are formed integrally in the bearing rings or are made from separate parts or are set in and mounted in the bearing rings. Planetary roller bodies with an outer profile complementary to the groove profiles are formed distributed around the circumference between the bearing rings. By meshing the groove profiles of the bearing rings with the outer profiles of the planetary roller bodies, a support is formed that is fixed in the axial direction and can rotate in the radial direction and in which a number of support surfaces, namely essentially a number of support surfaces corresponding to the number of grooves of the outer profiles, is formed between the bearing rings, so that the rotary table bearing device can have a smaller construction for a high load rating. Furthermore, a single roller bearing in the sense of a grooved ball bearing with significantly improved load rating can be provided in order to support the rotary table so that it can rotate and is fixed in the axial direction relative to the frame.

Through an arrangement of the rotational axes of the planetary roller bodies parallel to a rotational axis of the rotary table, the outer profiles of the planetary roller bodies, in connection with the groove profiles of the bearing rings, take over the axial load, while the rotation of the rotary table relative to the frame is performed by rolling of the outer profiles in the groove profiles. The bearing rings can here be arranged essentially in the radial direction one above the other in a plane. Depending on the embodiment, a bearing outer ring could be arranged on the frame and a bearing inner ring could be arranged on the rotary table, for example, with a threaded connection. In special embodiments, for example, rotary tables projecting in the radial direction beyond the frame, the bearing outer ring can also be connected to the rotary table and the bearing inner ring can be connected to the frame.

In the simplest case, a single row of planetary roller bodies distributed over the circumference can be provided. Here, a low axial play within teeth of the groove profiles with the outer profiles of the planetary roller bodies can be allowed. In the case of play freedom to be set, the teeth can be designed accordingly. Alternatively or additionally, pitch errors that axial pretension the bearing rings against each other in the axial direction can be provided in the groove profiles of one or both bearing rings and/or in the outer profile of the planetary roller bodies according to a specified function. In particular, for increasing the load bearing capacity and for improving the coaxial accuracy, several, preferably two rows of planetary roller bodies distributed around the circumference are arranged one next to the other in the axial direction. For forming an axial tensioning of the bearing rings, in addition to the named pitch errors, the groove profiles of at least two rows of planetary roller bodies can have a small axial offset.

In order to detect, for example, rotational characteristic values of the rotary table bearing device, a measurement device can be provided between the two rows of planetary roller bodies. For example, in the stationary bearing ring there can be a sensor element that detects encoder markings arranged between the rows of planetary roller bodies and detects from these markings the number of rotations, the rotational speed, rotational acceleration, and corresponding rotational characteristic values.

The installation of the rotary table bearing device is advantageously realized for an eccentric arrangement of the bearing rings through axial insertion of the planetary roller bodies between the bearing rings at the greatest radial distance of the bearing rings with subsequent separation of the planetary roller bodies to a provided uniform distance. The planetary roller bodies are preferably held in their position by a cage, for this purpose, the cage can be formed from two cage parts that are applied axially on both sides, for example, on journals formed on two sides on the ends of the planetary roller bodies and are then clipped, latched, or connected in some other way to each other. The connection can be realized by holding up the cage parts, for example, on one or more lubricating holes used for introducing lubricant. The cage parts can also have seals on both sides on the ends of the bearing rings forming seals between these pars.

According to an alternative method for inserting planetary roller bodies, in at least one of the bearing rings, a preferably axially formed filling channel can be provided with an at least slightly larger diameter than an outer diameter of the planetary roller bodies at a radial distance to a pitch circle of the installed planetary roller bodies, through which the planetary roller bodies are inserted in the axial direction one after the other between the bearing rings and can be placed onto the pitch circle from the outside in the radial direction through a radial opening Here, after each insertion of a planetary roller body, the other bearing ring not provided with the filling channel is rotated farther. In this way, a high degree of filling up to a nearly complete filling of the bearing rings with planetary rollers and thus increased load bearing capacities can be implemented. The filling channel and/or the radial opening can be provided as a hole that cuts through the corresponding groove profile of a bearing ring. The radial opening is closed by a filler plug that extends the missing groove profile of the hole on its inner side in an essentially dimensionally accurate and gap-less manner. For this purpose, during the formation of the groove profile, the filler plug can be already moved into its later end position, so that the groove profile is formed continuously in the bearing ring and the filler plug. A lubricating hole can be integrated in the filler plug. In addition to the planetary roller bodies, spacing parts at a distance in the circumferential direction can be inserted alternating with the planetary roller bodies through the filling channel.

### BRIEF DESCRIPTION OF THE DRAWINGS

The invention is described in more detail below with reference to the embodiments shown in FIGS. 1 to 5. Shown are:

FIG. 1 a partial view through a rotary table bearing device with a planetary roller bearing,

FIG. 2 a partial section through the rotary table bearing device of FIG. 1,

FIG. 3 a rotary table bearing device filled by a filling channel in partial view,

FIG. 4 a partial section through a rotary table bearing device with a two-row planetary roller bearing, and

FIG. 5 a partial section through a rotary table bearing device with a two-row planetary roller bearing and a measurement device arranged between the rows.

### DETAILED DESCRIPTION OF THE PREFERRED EMBODIMENTS

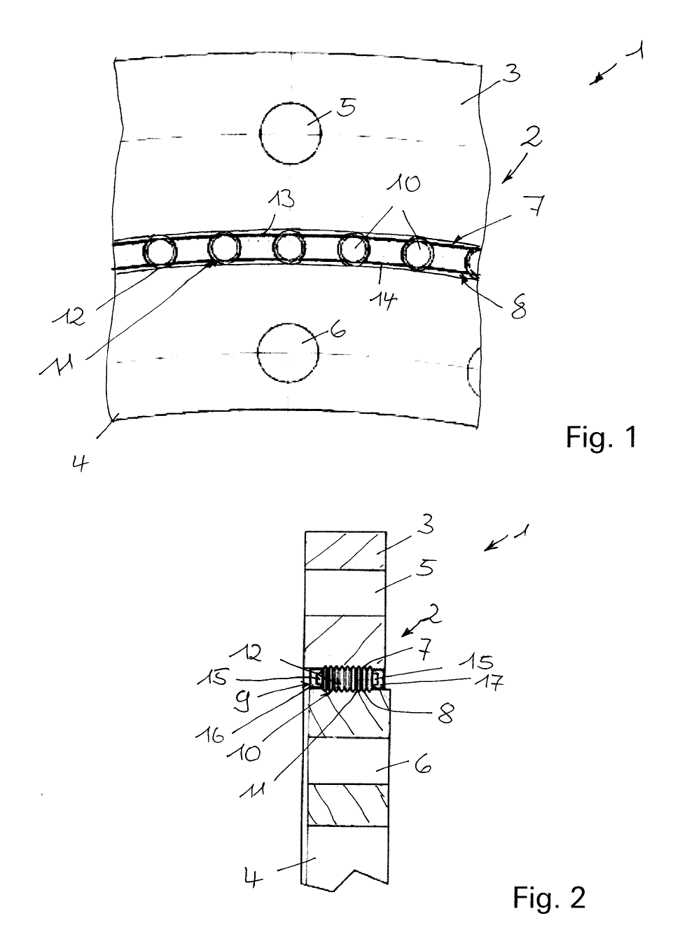

FIGS. 1 and 2 show, in a partial view and partial section, respectively, the rotary table bearing device 1 with a roller bearing formed as a planetary roller bearing 2. The planetary roller bearing 2 contains the two bearing rings 3, 4 that are formed integrally and radially one above the other and are held by the fastener openings 5, 6 on a frame or on a rotary table of a rotary table apparatus not shown in more detail. The bearing rings 3, 4 each have a raceway formed from the groove profiles 7, 8 for the planetary roller bodies 10 held at a distance to each other by the cage 9 and distributed uniformly over the circumference. The planetary roller bodies 10 mesh with their outer profiles 11 with the groove profiles 7, 8 and thus form a reinforced axial support structure in that the individual grooves 12, 13, 14 of the groove profiles 7, 8 are supported on one side and the outer profiles 11 are supported on the other side in the axial direction. The bearing rings 3, 4 are mutually slightly offset relative to each other, for example, by a groove 12, 13, 14, so that these can each be held flush on the frame and the rotary table under the adjustment of an axial play in the overlapping state between these parts. In the illustrated embodiment, the bearing ring 3 formed as a bearing outer ring can be held on the frame and the bearing ring 4 formed as the bearing inner ring can be held on the rotary table. The rotary table can here grip around the frame at least partially in the radial direction with axial play.

On both sides on the planetary roller bodies 10, a journal 15 is formed that uses the receptacle in the cage formed from the cage parts 16, 17. The planetary roller bodies 10 are here inserted for eccentrically arranged bearing rings 3, 4 at the greatest distance one after the other and separated at the specified distance. Then the cage parts 16, 17 are pushed from both sides onto the journal 15 and the cage parts are connected to each other. The cage parts 16, 17 form free spaces, such as pockets, between the planetary roller bodies 10, in which lubricant is housed. The ends of the cage parts 16, 17 can form seals closed over the circumference between the bearing rings 3, 4.

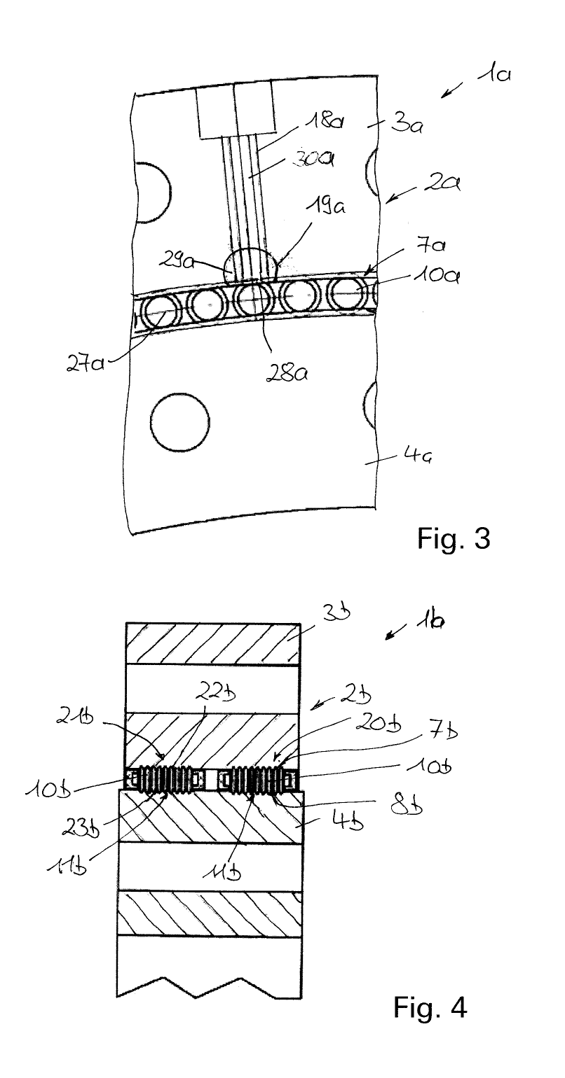

FIG. 3 shows a partial view of a rotary table bearing device 1a slightly changed relative to the rotary table bearing device 1 of FIG. 1 as the planetary roller bearing 2a. In contrast to the rotary table bearing device 1, for the rotary table bearing device 1a, the bearing rings 3a, 4a are filled by means of the insertion channel 19a that is here formed in the bearing ring 3a formed as an outer bearing ring in the axial direction under the cutting of the groove profile 7a, for example, as a hole. The insertion channel 19a is closed by the filler plug 29a after the installation of the planetary roller bodies 10a. The radial opening 18a formed, for example, as a hole, contains the clamping pin 30a that is used for the securing of the filler plug 29a and/or the lubrication via this radial opening 18a by a corresponding lubricating hole. The insertion channel 19a is designed so that the opening or the cut-out for the planetary roller bodies 10a to the groove profiles 7a is greater than their diameter. Here, the planetary roller bodies 10a are inserted one after the other while rotating the bearing ring 4a via the insertion channel 19a to the pitch circle 27a. Not-shown spacer parts or intermediate parts that are inserted alternately with the planetary roller bodies 10a through the insertion channel 19a form a distance between the individual planetary roller bodies 10a. The spacer parts can fulfill a sealing effect between the bearing rings 3a, 4a, so that lubricant cannot escape. The gaps 28a missing in the groove profile 7a in the area of the insertion channel 19a is closed by the filler plug 29a that is secured in its position by the radial securing pin 18a. This securing pin 18a can also be formed so that it can be used for local lubrication. For shown the groove profile filling the gaps 28a on the insertion channel 19a, the filler plug 29a is inserted and secured before forming the groove profile 7a in the insertion channel 19a and then processed together with the bearing ring 3a, so that a dimensionally accurate and essentially gap-less formation of the groove profile can be achieved on the filler plug.

FIG. 4 shows the rotary table bearing device 1b that is modified relative to the rotary table bearing devices 1, 1a of FIGS. 1 to 3 and has the two-row planetary roller bearings 2b. The two rows 20b, 21b of planetary roller bodies 10b formed preferably as identical parts are spaced from each other in the axial direction. Each row has groove profiles 7b, 8b, 22b, 23b formed separately on the bearing rings 3b, 4b for the outer profiles 11b of the planetary roller bodies 10b. The groove profiles 7b, 8b of the row 20b and the groove profiles 22b, 23b of the row 21b can be displaced slightly relative to each other in the axial direction with respect to their grooves, so that the planetary roller bodies are clamped axially relative to each other and the planetary roller bearing 2b enables an axial play-free support of the rotary table on the frame.

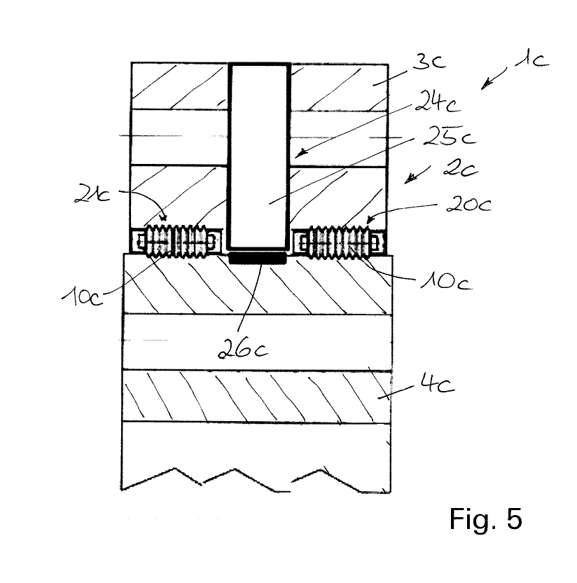

FIG. 5 shows, in modification relative to the rotary table bearing device 1b of FIG. 4, the rotary table bearing device 1c in partial section. Here, the measurement device 24c is arranged axially between the rows 20c, 21c of the planetary roller bodies 10c of the planetary roller bearing 2c. The measurement device 24c contains the sensor element 25c that is housed in the bearing ring 3c arranged rigidly in the frame between the rows 20c, 21c and generates excitation signals caused by the encoder ring 26c arranged on the rotating bearing ring 4c and containing, for example, magnetic markings. From the excitation signals, in a downstream evaluation device, for example, a control unit, rotational characteristic values of the rotary table, for example, number of rotations, rotational speed, rotational acceleration, synchronization, and the like, can be determined.

### LIST OF REFERENCE NUMBERS

1 Rotary table bearing device
1a Rotary table bearing device
1b Rotary table bearing device
1c Rotary table bearing device
2 Planetary roller bearing
2a Planetary roller bearing
2b Planetary roller bearing
2c Planetary roller bearing
3 Bearing ring
3a Bearing ring
3b Bearing ring
3c Bearing ring
4 Bearing ring
4a Bearing ring
4b Bearing ring
4c Bearing ring
5 Fastener opening
6 Fastener opening
7 Groove profile
7a Groove profile
7b Groove profile
8 Groove profile
8b Groove profile
9 Cage
10 Planetary roller body
10a Planetary roller body
10b Planetary roller body
10c Planetary roller body
11 Outer profile
11b Outer profile
12 Groove
13 Groove
14 Groove
15 Journal
16 Cage part
17 Cage part
18a Radial opening
19a Insertion channel
20b Row
20c Row
21b Row
21c Row
22b Groove profile
23b Groove profile
24c Measurement device
25c Sensor element
26c Encoder ring
27a Pitch circle
28a Gap
29a Filler plug
30a Clamping pin

1. A rotary table bearing device comprising a stationary frame, a rotary table supported for rotation and being fixed in an axial direction relative to the stationary frame by a roller bearing, the roller bearing is formed from a single planetary roller bearing with a first bearing ring allocated to the frame and a second bearing ring allocated to the rotary table the first and the second bearing rings having groove profiles, and planetary roller bodies arranged distributed around a circumference with an outer profile complementary to and engaging in the groove profiles.

2. The rotary table bearing device according to claim 1, wherein axes of rotation of the planetary roller bodies are arranged in parallel to an axis of rotation of the rotary table.

3. The rotary table bearing device according to claim 1, wherein several rows of the planetary roller bodies distributed around the circumference are arranged one next to the other in an axial direction.

4. The rotary table bearing device according to claim 3, wherein there are two of the rows of the planetary roller bodies, and the two rows of the planetary roller bodies are pretensioned in the axial direction against each other to the groove profiles of the bearing rings.

5. The rotary table bearing device according to claim 1, further comprising an axial insertion channel located in one of the bearing rings that is spaced apart in a radial direction to a pitch circle of the planetary roller bodies and a radial opening cutting the insertion channel, and a filler plug that closes the insertion channel, the a filler plug is fixed by a clamping pin held in the radial opening.

6. The rotary table bearing device according to claim 4, wherein a measurement device is provided between the two rows.

7. The rotary table bearing device according to claim 1, further comprising spacer parts provided between the planetary roller bodies in a circumferential direction.

8. The rotary table bearing device according to claim 1, further comprising a cage, and the planetary roller bodies are held by end-side journals in the cage.

9. The rotary table bearing device according to claim 8, wherein the cage is formed from two cage parts that are inserted from one side of the planetary roller bodies on journals and locked to each other.

10. The rotary table bearing device according to claim 8, wherein the cage forms a seal between the bearing rings on both sides in the axial direction.
